(19) United States
(12) Patent Application Publication
(10) Pub. No.: US 2011/0255040 A1
(43) Pub. Date: Oct. 20, 2011

(54) LIQUID CRYSTAL DISPLAY PANEL

(76) Inventors: Yi-Hau Shiau, Hsin-Chu (TW); Hsin-An Cheng, Hsin-Chu (TW); Yang-Chu Lin, Hsin-Chu (TW); Li-Wei Kung, Hsin-Chu (TW); Norio Sugiura, Hsin-Chu (TW); Meng-Hsi Chan, Hsin-Chu (TW); Chun-Ming Wu, Hsin-Chu (TW); Chia-Ting Hsiao, Hsin-Chu (TW); Liang-Yin Huang, Hsin-Chu (TW)

(21) Appl. No.: 13/083,606

(22) Filed: Apr. 11, 2011

(30) Foreign Application Priority Data
Apr. 20, 2010 (TW) 099112346
Jul. 14, 2010 (TW) 099123152

(51) Int. Cl. G02F 1/1337

(52) U.S. Cl. 349/123

(57) ABSTRACT

A liquid crystal display panel includes a first substrate, a second substrate, an active layer, a first alignment film, a second alignment film, a liquid crystal layer, and a sealant. The first substrate includes a display region and a sealant region encompassing the display region. The second substrate is disposed oppositely to the first substrate. The liquid crystal layer is disposed between the first alignment film and the second alignment film. The liquid crystal layer includes a plurality of liquid crystal molecules, wherein the dielectric anisotropy of the liquid crystal molecules is substantially equal to or greater than 7, or substantially equal to or less than −4. The sealant is disposed between the first substrate and the second substrate, and is disposed in the sealant region. The sealant includes acrylics, wherein a weight percentage of acrylics is substantially between 50 wt % and 90 wt %.

### BACKGROUND OF THE DISCLOSURE

1. Field of the Disclosure

The present disclosure relates to a liquid crystal display panel, and more particularly, to a liquid crystal display panel using liquid crystal molecules with high dielectric anisotropy to reduce probability of generating around mura.

2. Description of the Prior Art

In comparison with conventional cathode ray tube (CRT) display, liquid crystal display (LCD) panel is becoming the main display device because of its thin appearance, low power consumption, and low radiation. The conventional method of filling with the liquid crystal between the substrates includes vacuum fill method and one drop fill (ODF) method. Vacuum fill method is carried out by the following steps. Two substrates are disposed oppositely, and sealed by a sealant (usually includes thermo curable materials). Then, after the sealant is cured, liquid crystal molecule is filled into the space formed by the substrates and the sealant by capillarity phenomenon through a reserved opening. Finally, the opening is closed by sealant. The vacuum fill method, however, suffers from shift of the thermo curable materials of the sealant and is time-consuming, and thus is normally applied in small size panels.

Recently, one drop fill method, which uses optical curable materials as its sealant, has been developed. One drop fill method is carried out by the following steps First of all, sealant with hollow rectangular pattern is formed on one of the substrates. Then, before the sealant is cured, the liquid crystal molecules are dropped inside the hollow rectangular pattern, and the substrate is assembled with the other substrate immediately. Then the hollow rectangular pattern is exposed under UV to harden the sealant so that the sealant may combine the two substrates without shifting. Because the one drop fill method needs less time and the optical curable sealant has better quality, currently, most liquid crystal display panel are fabricated by one drop fill method.

In comparison with the vacuum fill method, the one drop fill method, though, may reduce time of filling the liquid crystal, non-uniformity of color may occur around the panel, which is referred to as around mura, due to the contact of the incompletely cured sealant and the liquid crystal molecules that have similar polarities. Please refer to FIG. 1 and FIG. 2. FIG. 1 is a schematic diagram illustrating around mura caused by the sealant molecule dissolved in the liquid crystal layer in the conventional liquid crystal display panel, and FIG. 2 is a cross-sectional view of the liquid crystal display panel taken along line A-A′ in FIG. 1. As shown in FIG. 1 and FIG. 2, the conventional liquid crystal display panel 100 includes two substrates 102 and 104, two alignment films 106 and 108 disposed on the inner side of the two substrates 102 and 104, respectively, a liquid crystal layer 112 sandwiched between the two alignment films 106 and 108, and a sealant 110 disposed around the substrates 102 and 104. The liquid crystal molecules of the liquid crystal layer 112 is disposed in the space formed by the substrates 102 and 104 and the sealant 110.

Generally, the liquid crystal molecules of the liquid crystal layer 112 are arranged regularly because of the alignment function of the alignment films 106 and 108. However, according above, the sealant 110, which has similar polarity to the polarity of the liquid crystal molecule, would dissolve in the liquid crystal layer 112 because of the “like dissolves like” theory, and therefore forms the impurity 114 of the liquid crystal layer 112. The impurity 114 would disturb the arrangement of the liquid crystal molecules so that the liquid crystal molecules would not be driven by the electrical field and twisted. The around mura 116 which is permanently bright or dark is generated and dispersed in the interface between the sealant 110 and the liquid crystal layer 112 (as shown in FIG. 1). The around mura is observable by eyes, and reduces the display quality of the liquid crystal display panel 100. Thus, the around mura becomes one of the problems for the liquid crystal display panel to be improved.

### SUMMARY OF THE DISCLOSURE

It is therefore one of the objectives of the present disclosure to provide a liquid crystal display panel to effectively reduce the around mura.

In accordance with an embodiment of the present disclosure, a liquid crystal display panel includes a first substrate, a second substrate, an active layer, a first alignment film, a second alignment film, a liquid crystal layer, and a sealant. The first substrate includes a display region and a sealant region. The sealant region is encompassing the display region. The second substrate is disposed oppositely to the first substrate. The active layer is disposed on the first substrate and includes a plurality of pixel areas. The pixel areas are disposed in the display region. The first alignment film is disposed on the active layer, and the second alignment film is disposed on a side of the second substrate facing the active layer. The liquid crystal layer is disposed between the first alignment film and the second alignment film, the liquid crystal layer includes a plurality of liquid crystal molecules, and an absolute value of the dielectric anisotropy of the liquid crystal molecules is substantially equal to or larger than 7. The sealant is disposed between the first substrate and the second substrate and in the sealant region. The liquid crystal layer is disposed in a space formed by the first substrate, the second substrate, and the sealant. The sealant includes acrylics and a weight percentage of the acrylics is substantially equal to or larger than 50 wt % and equal to or less than 90 wt %.

In accordance with another embodiment of the present disclosure, a liquid crystal display panel includes a first substrate, a second substrate, an active layer, a first alignment film, a second alignment film, a liquid crystal layer, and a sealant. The first substrate includes a display region and a sealant region. The sealant region is encompassing the display region. The second substrate is disposed oppositely to the first substrate. The active layer is disposed on the first substrate and includes a plurality of pixel areas. The pixel areas are disposed in the display region. The first alignment film is disposed on the active layer, and the second alignment film is disposed on a side of the second substrate facing the active layer. The liquid crystal layer is disposed between the first alignment film and the second alignment film and the liquid crystal layer includes a plurality of liquid crystal molecules. The sealant is disposed between the first substrate and the second substrate and in the sealant region. The liquid crystal layer is disposed in a space formed by the first substrate, the second substrate, and the sealant. A polarity of the sealant is substantially larger than a polarity of the liquid crystal layer.

In accordance with another embodiment of the present disclosure, a liquid crystal display panel includes a first substrate, a second substrate, an active layer, a first alignment film, a second alignment film, a liquid crystal layer, and a sealant. The first substrate includes a display region and a sealant region. The sealant region is encompassing the display region. The second substrate is disposed oppositely to the first substrate. The active layer is disposed on the first substrate and includes a plurality of pixel areas disposed in the display region. The first alignment film is disposed on the active layer, and the second alignment film is disposed on a side of the second substrate facing the active layer. The liquid crystal layer is disposed between the first alignment film and the second alignment film, the liquid crystal layer includes a plurality of liquid crystal molecules, and a dielectric anisotropy of the liquid crystal molecules is substantially equal to or less than −4. The sealant is disposed between the first substrate and the second substrate and in the sealant region. The liquid crystal layer is disposed in a space formed by the first substrate, the second substrate, and the sealant. The sealant includes acrylics and a weight percentage of acrylics is substantially equal to or larger than 50 wt % and equal to or less than 90 wt %.

The liquid crystal display panel of the present disclosure is able to effectively avoid around mura caused by the dissolution of the sealant molecules in the liquid crystal layer, and is applicable to the liquid crystal display panel with low driving voltage which conforms with a trend of eco-friendly and energy saving.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating around mura caused by the sealant molecule dissolved in the liquid crystal layer in the conventional liquid crystal display panel.

FIG. 2 is a cross-sectional view of the liquid crystal display panel taken along line A-A′ in FIG. 1.

FIG. 3 and FIG. 4 are schematic diagrams illustrating a liquid crystal display panel according to a first embodiment of the present invention.

FIG. 5 is a bar chart illustrating the ratio of around mura with respect to different weight percentage of acrylics.

FIG. 6 is a bar chat illustrating a relation between the percentage of acrylics and voltage holding ratio of the liquid crystal molecules.

FIG. 7 is a schematic diagram illustrating a relation between the transmittance and the liquid crystal molecules with different dielectric anisotropies and driving voltages in the present invention.

FIG. 8 illustrates an optoelectronic device of the embodiment of the present invention.

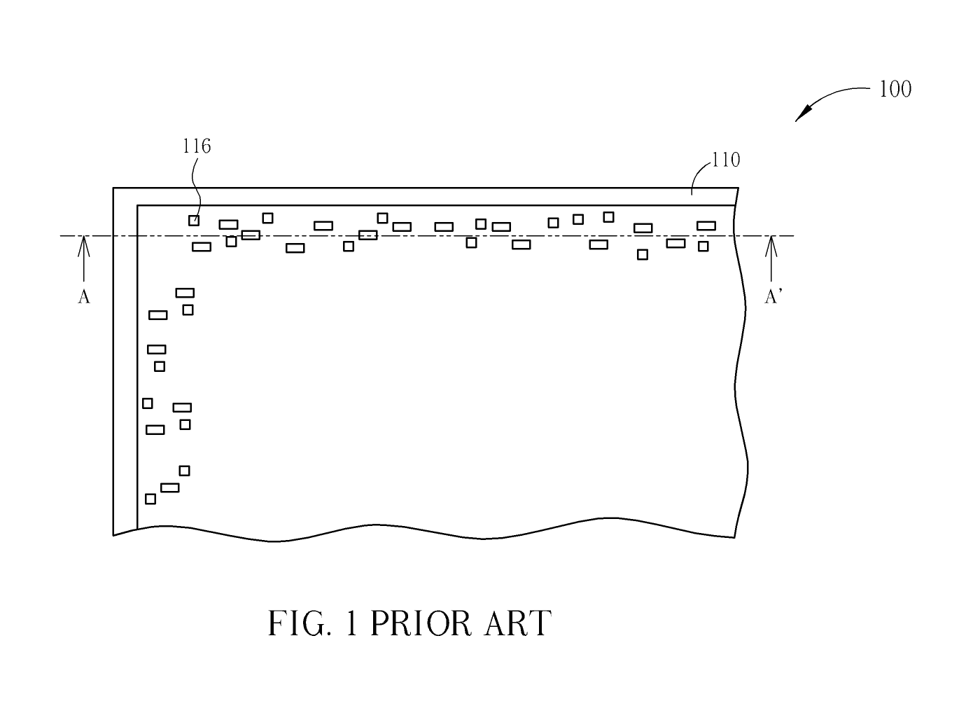

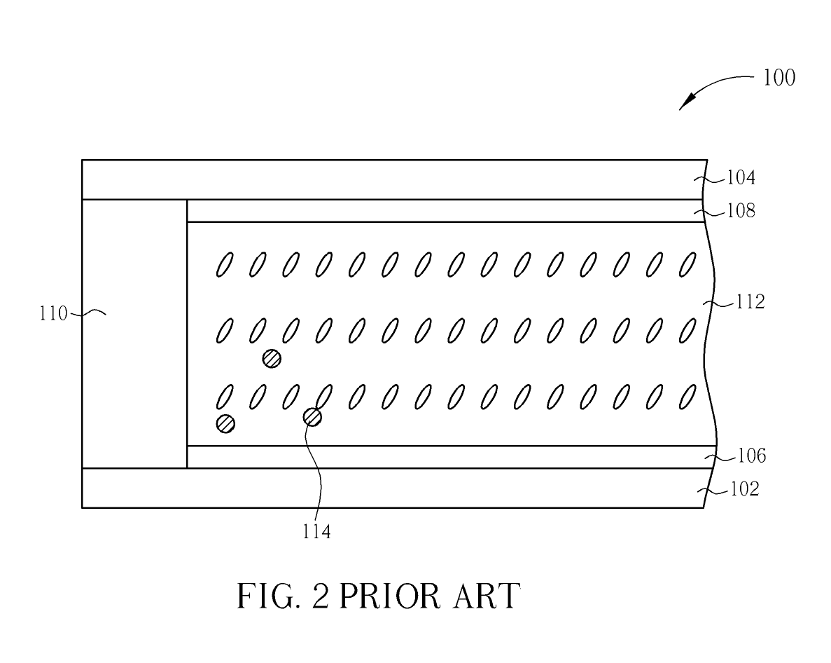

### DETAILED DESCRIPTION

To provide a better understanding of the present disclosure, preferred embodiments will be made in detail. The preferred embodiments of the present disclosure are illustrated in the accompanying drawings with numbered elements.

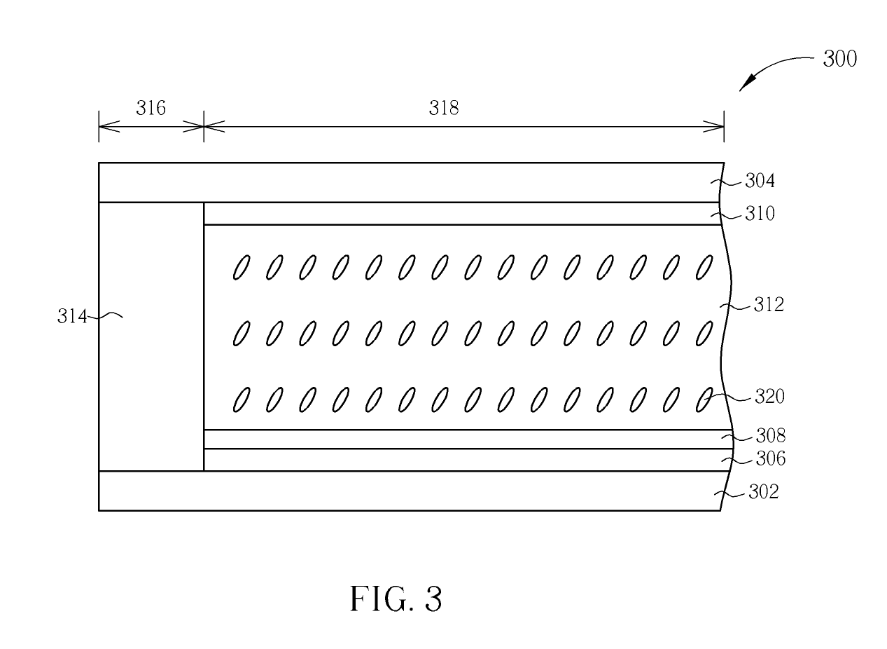

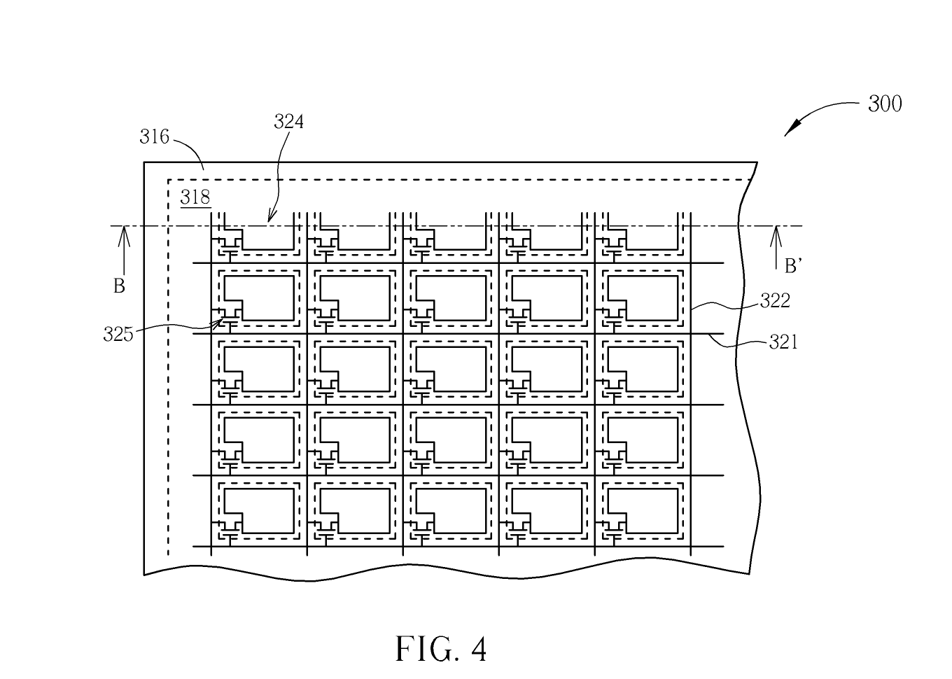

Please refer to FIG. 3 and FIG. 4. FIG. 3 and FIG. 4 are schematic diagrams illustrating a liquid crystal display panel according to a first embodiment of the present disclosure. FIG. 3 is a cross-sectional view of the liquid crystal display panel taken along line B-B′ in FIG. 4. As shown in FIG. 3, a liquid crystal display panel 300 of this embodiment includes a first substrate 302, a second substrate 304, an active layer 306, a first alignment film 308, a second alignment film 310, a liquid crystal layer 312, and a sealant 314. The first substrate 302 and the second substrate 304 are substantially parallel to each other and disposed oppositely. The first substrate 302 and the second substrate 304 may be rigid substrates, such as glass substrates, quartz substrates, and plastic substrates, and may also be flexible substrates made of flexible materials. In this embodiment, the first substrate 302 is a thin film transistor substrate and the second substrate 304 is a color filter substrate, but not limited thereto. For example, the first substrate 302 may be a color filter on array (COA) substrate or a black matrix on array (BOA) substrate. Moreover, the first substrate 302 may include a display region 318 and a sealant region 316. As shown in FIG. 4, the sealant region 316 is disposed around and encompassing the display region 318.

The active layer 306 is disposed on the first substrate 302, and includes electrical devices which can drive the liquid crystal layer 312. As shown in FIG. 4, the active layer 306 includes a plurality of scanning lines 321 and a plurality of data lines 322. Each of the scanning lines 321 and each of the data lines 322 are intersected so that the active layer 306 defines a plurality of pixel areas 324 in the display region 318. In this embodiment, the active layer 306 also has a plurality of thin film transistors 325. At least one thin film transistor 325 is disposed in each of the pixel areas 324. The thin film transistor 325 in the corresponding pixel area 324 can be turned on by the signals provided by the scanning line 321, so that appropriate pixel voltage delivered by the data line 322 can be provided for different pixel areas 324. It is appreciated that in addition to the scanning lines 321, the data lines 322, the thin film transistors 325 and the pixel areas 324, the active layer 306 may further include other electrical devices, such as storage capacitors (not shown) and common lines (not shown), and even may include other electrical devices disposed in the sealant region 316, such as scanning line bus lines, data line bus lines, test lines, test bus lines, contact pads, sensing circuits, detecting circuits, bypass circuits, dummy circuits, dummy pixels, switch circuits, connected circuits, driving circuits, control circuits, any other circuits needed in design, or a combination of at least two thereof.

Please refer to FIG. 3 again. The first alignment film 308 is disposed on the active layer 306, the second alignment film 310 is disposed on a side of the second substrate 304 which faces the first substrate 302, and the liquid crystal layer 312 is disposed between the first alignment film 308 and the second alignment film 310. There are alignment scratches (not shown) formed on the first alignment film 308 and the second alignment film 310 to make the liquid crystal molecules 320 be arranged regularly in a prearranged alignment direction. The sealant 314 is disposed between the first substrate 302 and the second substrate 304, and in the sealant region 316 of the first substrate 302 to make the liquid layer 312 disposed in a space formed by the sealant 314, the first substrate 302, and the second substrate 304.

To avoid the around mura that is caused by the dissolution of the materials of the sealant 314 in the liquid crystal layer 312, the liquid crystal display panel 300 of this embodiment has a sealant 314 and liquid crystal molecules 320 with specific materials. For example, the sealant 314 of this embodiment includes acrylics. In other embodiments, other additives may be added according to the requirement of design, such as hardener, linking agent, initiator, accelerator, inhibitor, dye, pigment, co-polymerizable monomer, additive, leveling agent, adhesive, antifoam agent, any other appropriate additives, or a combination of at least two thereof. In this embodiment, the sealant 314 includes acrylics and additives, such as hardener and initiator, but not limited thereto. In this embodiment, acrylics include compounds formed from the reactions of double bonding functional groups and epoxy functional groups, such as acrylic monomers, acrylyl monomers, epoxy monomers, isocyanate monomers, or mixtures thereof. For example, the acrylics of this embodiment may include at least one or a combination of the following function groups: acrylic acid, methyl (meth)acrylate, methacrylic acid, 2-hydroxyethyl acrylate, 2-hydroxypropyl (meth)acrylate, 4-hydroxybutyl (meth)acrylate, 2-hydroxybutyl (meth)acrylate, isobutyl (meth)acrylate, tert-butyl (meth)acrylate, isooctyl (meth)acrylate, lauryl (meth)acrylate, stearyl (meth)acrylate, isobornyl (meth)acrylate, cyclohexyl (meth)acrylate, 2-methoxyethyl (meth)acrylate, methoxyethylene glycol (meth)acrylate, 2-ethoxyethyl (meth)acrylate, tetrahydrofurfuryl (meth)acrylate, benzyl (meth)acrylate, diethylene glycol monoethyl ether, phenoxyethyl (meth)acrylate, phenoxydiethylene glycol (meth)acrylate, phenoxypolyethylene glycol (meth)acrylate, methoxypolyethylene glycol (meth)acrylate, 2,2,2-trifluoroethyl (meth)acrylate, 2,2,3,3-tetrafluoropropyl (meth)acrylate, 1H,1H,5H-octafluoropentyl (meth)acrylate, imide (meth)acrylate, methyl (meth)acrylate, ethyl (meth)acrylate, propyl (meth)acrylate, n-butyl (meth)acrylate, cyclohexyl (meth)acrylate, 2-ethylhexyl (meth)acrylate, n-octyl (meth)acrylate, isononyl (meth)acrylate, isomyristyl (meth)acrylate, 2-butoxyethyl (meth)acrylate, 2-phenoxyethyl (meth)acrylate, bicyclopentenyl (meth)acrylate, isodecyl (meth)acrylate, diethylaminoethyl (meth)acrylate, dimethylaminoethyl (meth)acrylate, 2-(meth)acryloyloxyethyl succinate, 2-(meth)acryloyloxyethyl hexahydrophthalate, 2-(meth)acryloyloxyethyl 2-hydroxypropyl phthalate, glycidyl (meth)acrylate, 2-(meth)acryloyloxyethyl phosphate, 1.4-butanediol di(meth)acrylate, 1.3-butanediol di(meth)acrylate, 1,6-hexanediol di(meth)acrylate, 1,9-nonanediol di(meth)acrylate, 1,10-decanediol di(meth)acrylate), 2-n-butyl-2-ethyl-1,3-propanediol di(meth)acrylate, dipropylene glycol di(meth)acrylate, tripropylene glycol di(meth)acrylate, polypropylene glycol (meth)acrylate, ethylene glycol di(meth)acrylate, diethylene glycol di(meth)acrylate, tetraethylene glycol di(meth)acrylate, polyethylene glycol di(meth)acrylate, propylene oxide adduct of bisphenol A di(meth)acrylate, ethylene oxide adduct of bisphenol A di(meth)acrylate, ethylene oxide adduct of bisphenol F di(meth)acrylate, dimethylol-dicyclopentadien di(meth)acrylate, 1,3-butylene glycol di(meth)acrylate, neopentyl glycol di(meth)acrylate, ethylene oxide modified di(meth)acrylate isocyanurate, 2-hydroxy-3-(meth)acryloyloxypropyl (meth)acrylate, carbonatediol di(meth)acrylate, polyetherdiol di(meth)acrylate, polyesterdiol di(meth)acrylate, polycaprolactonediol di(meth)acrylate, and polybutadiendiol di(meth)acrylate, and etc.

The hardener is a bridge for the polymerization of the acrylics, such as amines, but not limited thereto. The initiator may be a thermal initiator (such as 2,2′-azobisisobutyronitrile, but not limited thereto), photo initiator (such as peroxide radical initiator or azo radical initiators, such as diethoxy acetophenone, benzophenone, and benzyl benzoin isobutyl ether, but not limited thereto), or a combination of initiators mentioned above. Moreover, the sealant 314 of this embodiment further includes filler, such as silicate, other additives, such as silane, or others, such as leveling agent, adhesive, or antifoam agent.

Another specification of this embodiment is that the weight percentage of the acrylics is about 50 wt % to about 90 wt % of the sealant 314, which is to say, the weight percentage of the acrylics is substantially equal to or larger than 50 wt % and substantially equal to or less than 90 wt % (or namely the weight percentage of the acrylics is between about 50 wt % and 90 wt %). In the preferred embodiment of the present invention, the weight percentage of the acrylics is substantially equal to or larger than 80 wt % and equal to or less than 90 wt % (or namely the weight percentage of the acrylics is between about 80 wt % and 90 wt %). When the ratio of acrylics to the sealant 314 is within the above range, the polarity of the sealant 314 would be increased and therefore larger than the polarity of the liquid crystal molecules 320, so that it can prevent the molecules of the sealant 314 from dissolving in the liquid crystal layer 312 because of the similar polarities. As a result, no around mura will occur.

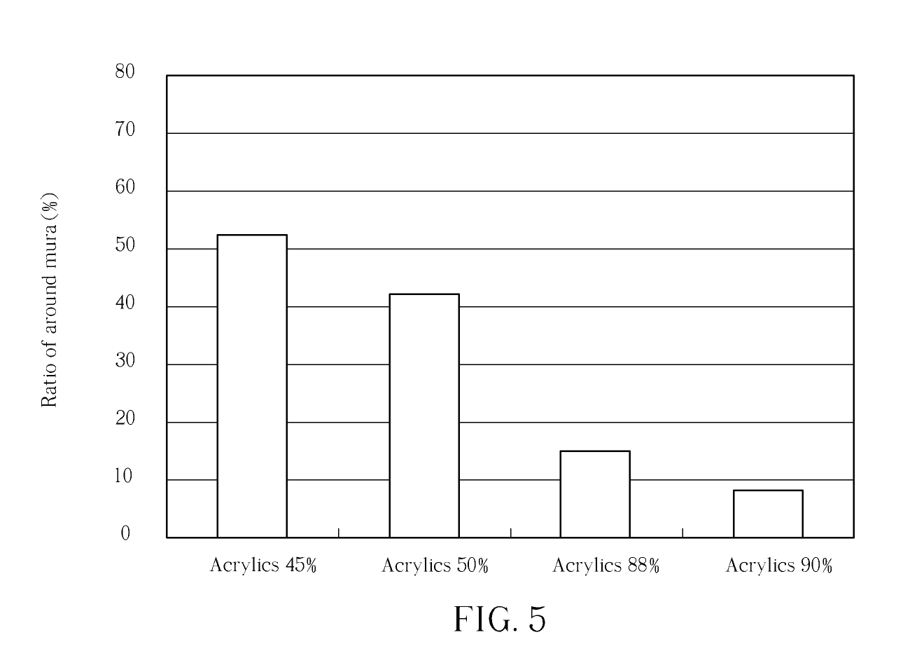

Please refer to FIG. 5. FIG. 5 is a bar chart illustrating the ratio of around mura with respect to different weight percentage of acrylics, wherein the x-axis is weight percentage of acrylics and the y-axis is the ratio of around mura. The ratio of around mura is defined by the number of the pixel areas with around mura divided by the total number of the pixel areas, which is, (number of pixel areas with around mura/total number of pixel areas)*100%. In this embodiment, three pixel areas form a pixel display region, but not limited thereto. In other embodiments, a pixel display region could be combined by four, five, or six pixel areas. As shown in FIG. 5, by increasing the ratio of acrylics, it is obvious that the ratio of around mura is decreasing. Especially at the weigh percentage of acrylics is larger than 50 wt % and there is a significant decrease of around mura.

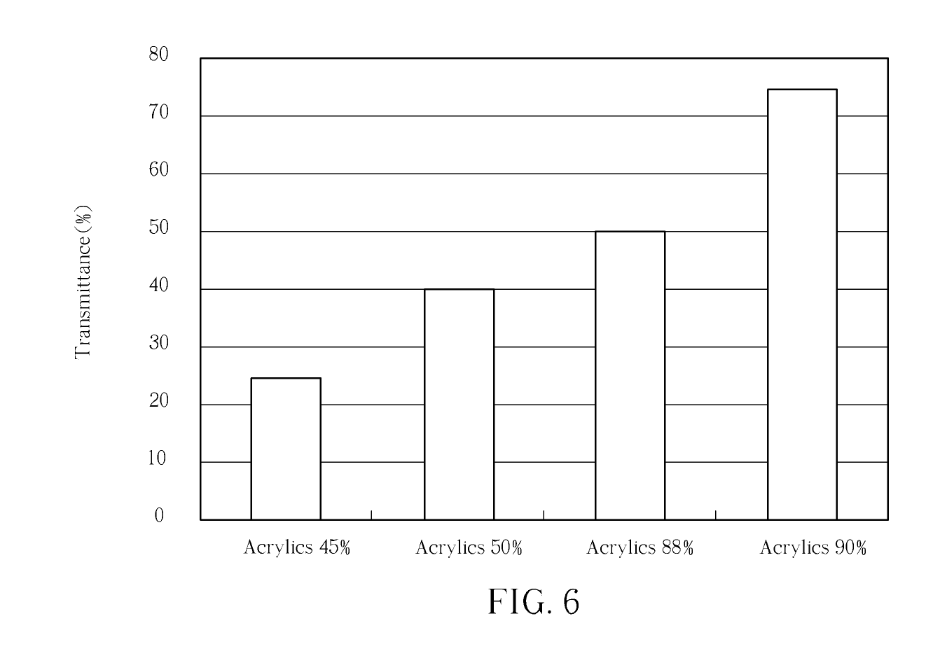

Please refer to FIG. 6. FIG. 6 is a bar chat illustrating a relation between the percentage of acrylics and voltage holding ratio of the liquid crystal molecules, wherein the x-axis is weight percentage of acrylics and the y-axis is voltage holding ratio of the liquid crystal molecules. The voltage holding ratio of the present invention is the ratio of liquid crystal molecules in twisted condition when driven by the voltage of about 1 volt and about 0.6 Hz. A higher voltage holding ratio represents the higher ratio of the liquid crystal molecules in twisted condition, and lower power consumption. As shown in FIG. 6, as the weight percentage of acrylics increases, the voltage holding ratio of the liquid crystal molecules increases as well. As the weight percentage of acrylics is about 50 wt %, the voltage holding ratio is about 40%; as the weight percentage of acrylics is about 88 wt %, the voltage holding ratio is about 50%; and as the weight percentage of acrylics is about 90 wt %, the voltage holding ratio is about 75%. Thus, from FIG. 6, the liquid crystal display panel of the present disclosure is much effective in energy-saving.

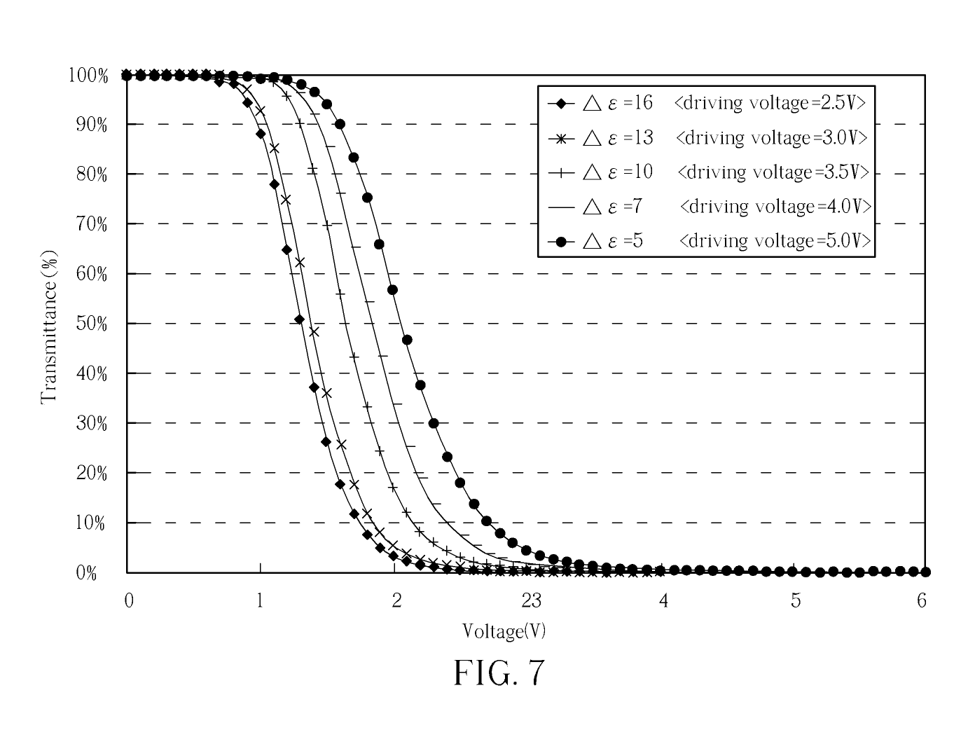

In addition, the design of the liquid crystal display panel 300 of the present disclosure may further combines the liquid crystal molecules with low driving voltage, such as the liquid crystal molecules with dielectric anisotropy (Δ∈) larger than 7 to meet the eco-friendly and energy saving trend. Generally, the dielectric anisotropy of the liquid crystal molecules may affect the driving voltage thereof. Please refer to FIG. 7. FIG. 7 is a schematic diagram illustrating a relation between the transmittance and the liquid crystal molecules with different dielectric anisotropies and driving voltages in the present disclosure, wherein the x-axis is applying voltages and the y-axis is transmittance. As shown in FIG. 7, the voltage-transmittance curve is different when the liquid crystal molecules with different dielectric anisotropies are used. The difference of dielectric anisotropies also means the difference of driving voltages. It can be seen from FIG. 7 that the higher dielectric anisotropy the liquid crystal molecules have (for instance, the liquid crystal molecules with dielectric anisotropy of about 16), the lower driving voltage the liquid crystal molecules have. That is to say, the transmittance can be tuned from 0% to 100% with lower voltage. Therefore, the liquid crystal display panel of the present disclosure uses the liquid crystal molecules with high dielectric anisotropy, such as liquid crystal molecules with dielectric anisotropy is substantially equal to or larger than 7, to accomplish energy-saving by low driving voltage. It is preferred that the dielectric anisotropy of the liquid crystal molecules is substantially equal to or larger than 7. However, liquid crystal molecules with higher dielectric anisotropy normally have high polarities as well, and therefore the high dielectric anisotropy would reduce the difference between the polarities of the liquid crystal molecules and that of the sealant. Thus, around mura tends to occur to the liquid crystal display panel with low driving voltage. It is appreciated that the liquid crystal molecules with dielectric anisotropy is substantially equal to or larger than 7 in this embodiment means the absolute value of dielectric anisotropy (|Δ∈|) is substantially equal to or larger than 7. The liquid crystal molecules may be positive liquid crystal molecules having the dielectric anisotropy is substantially equal to or larger than 7. In other embodiments, the liquid crystal molecules may be negative liquid crystal molecules having dielectric anisotropy is substantially equal to or less than −7.

The liquid crystal display panel 300 in this embodiment may efficiently resolve the problem. By increasing the percentage of acrylics, the liquid crystal display panel 300 in this embodiment enlarges the polarity difference between the sealant 314 and the liquid crystal molecules 320. Therefore, even the liquid crystal molecules 320 with high dielectric anisotropy is combined, the polarity of the sealant 314 is still far larger than the polarity of the liquid crystal molecule 30 so that there would not be the problem of having lower driving voltage accompanying with around mura. For example, the dielectric anisotropy of the liquid crystal molecules 20 of this embodiment may be substantially equal to or larger than 7, such as between about 7 and about 25. It is preferred that the dielectric anisotropy of the liquid crystal molecules 320 of this embodiment is between about 7 and about 14. In other words, the dielectric anisotropy of the liquid crystal molecules 320 is substantially equal to or larger than 7 and substantially equal to or less than 25. It is preferred that the dielectric anisotropy of the liquid crystal molecules 320 is substantially equal to or larger than 7 and substantially equal to or less than 14. The liquid crystal molecules 320 of this embodiment may be any kind of liquid crystal materials, such as nematic liquid crystal, cholesteric liquid crystal, or smectic liquid crystal. It is preferred that the liquid crystal molecule 320 of this embodiment is a twisted nematic (TN) liquid crystal molecule, but not limit thereto. For example, the liquid crystal molecule 320 of this embodiment may also be a super twisted nematic (STN) liquid crystal molecule, a smectic A type liquid crystal molecule, a smectic B type liquid crystal molecule, a smectic C type liquid crystal molecule, a polymer dispersed liquid crystal (PDLC) molecule, a polymer network liquid crystal (PNLC) molecule, or polymer-stabilized cholesteric texture (PSCT) liquid crystal molecule, but not limited thereto. The liquid crystal display panel 300 may be liquid crystal display panels with different driving modes, such as vertical alignment (VA) liquid crystal display panel, in-plane switch (IPS) liquid crystal display panel, multi-domain vertical alignment (MVA) liquid crystal display panel, twisted nematic (TN) liquid crystal display panel, super twisted nematic (STN) liquid crystal display panel, patterned-silt vertical alignment (PVA) liquid crystal display panel, super patterned-silt vertical alignment (S-PVA) liquid crystal display panel, advance super view (ASV) liquid crystal display panel, fringe field switching (FFS) liquid crystal display panel, continuous pinwheel alignment (CPA) liquid crystal display panel, axially symmetric aligned micro-cell mode (ASM) liquid crystal display panel, optical compensation bend (OCB) liquid crystal display panel, super in plane switching (S-IPS) liquid crystal display panel, advanced super in plane switching (AS-IPS) liquid crystal display panel, ultra-fringe field switching (UFFS) liquid crystal display panel, polymer stable alignment liquid crystal display panel, electrical paper, blue phase display, dual-view liquid crystal display panel, triple-view liquid crystal display panel, three-dimensional liquid crystal display panel, any other kinds liquid crystal display panel, or a combination of liquid crystal display panels mentioned above.

In another embodiment of the present disclosure, if the liquid crystal molecules 320 are negative liquid crystal molecule, the dielectric anisotropy of the liquid crystal molecule 320 may be substantially equal to or less than −4 (or namely the dielectric anisotropy of the liquid crystal molecule≦−4), for instance, the dielectric anisotropy of the liquid crystal molecule 320 is substantially equal to or less than −4 and substantially equal to or larger than −25 (or namely the dielectric anisotropy of the liquid crystal molecule is between about −4 and about −25), which is preferred that the dielectric anisotropy of the liquid crystal molecule 320 is substantially equal to or less than −7 and substantially equal to or larger than −14 (or namely the dielectric anisotropy of the liquid crystal molecule is between about −7 and about −14). In this embodiment, the liquid crystal molecule 320 is preferred to be a vertical alignment liquid crystal molecule, but is not limited thereto. In other words, the liquid crystal molecule 320 may be any other liquid crystal molecules, and the liquid crystal display panel may be any types of liquid crystal display panels mentioned above.

In the liquid crystal display panel of another embodiment of the present disclosure, the structure and the materials are substantially the same with the first embodiment (please refer to FIG. 3 and FIG. 4), and are not redundantly described here. In order to avoid the around mura caused by the similarity between the polarity of the sealant 314 and the polarity of the liquid crystal molecule 320, the polarity of the sealant 314 of the liquid crystal display panel 300 is larger than the polarity of the liquid crystal molecule 320 in this embodiment. The polarity mentioned in this embodiment may be measured by the amount of hydrogen-bonding functional groups, which can be further represented by soluble parameter (SP) value. The SP value is a ratio of the energy of vaporization (Δei) to the molar volume (Δvi) under 25° C. In the liquid crystal display panel 300 of this embodiment, the polarity of the sealant 314 is substantially larger than the polarity of the liquid crystal layer 312. In the preferred embodiment of the present disclosure, the difference of the polarities is preferred substantially larger than or equal to 2. More preferably, the difference of the polarities is substantially larger than 2. For example, the polarity (soluble parameter value) of the liquid crystal molecule 320 of this embodiment is substantially between 20 and 22, and the polarity of the sealant 314 (soluble parameter value) is substantially equal to or larger than 23. The polarity of the sealant 314 is preferably substantially between 23 and 27. In other words, the polarity of the liquid crystal molecule 320 is substantially larger than or equal to 20 and less than or equal to 22 (or namely the polarity of the liquid crystal molecule is between about 20 and 22), and the polarity of the sealant 314 is substantially larger than or equal to 23 and less than or equal to 27 (or namely the polarity of the sealant is between about 23 and 27).

In the liquid crystal display panel 300 of another embodiment of the present disclosure, the structure and the materials are substantially the same with the embodiments mentioned above, but the dielectric anisotropy of the liquid crystal molecule 320 is substantially larger than 7 and the weight percentage of the acrylics of the sealant 314 is substantially larger than or equal to 50 wt % and substantially less than or equal to 90 wt %. On the other hand, the polarity of the sealant 314 is substantially larger than the polarity of the liquid crystal molecule 320. It is preferred that the difference of the polarities is substantially larger than 2. For example, the polarity (soluble parameter value) of the liquid crystal molecule 320 is substantially between 20 and 22, and the polarity (soluble parameter value) of the sealant 314 is substantially larger than or equal to 23. It is preferred that the polarity (soluble parameter value) of the sealant 314 is substantially between 23 and 27. In other words, the polarity of the liquid crystal molecule 320 is substantially larger than or equal to 20 and substantially less than or equal to 22 (or namely the polarity of the liquid crystal molecule is between about 20 and 22), and the polarity of the sealant 314 is substantially larger than or equal to 23 and less than or equal to 27 (or namely the polarity of the sealant is between about 23 and 27). In another embodiment of the present disclosure, the dielectric anisotropy of the liquid crystal molecule 320 is substantially less than or equal to −4 and the weight percentage of the acrylics of the sealant 314 is substantially larger than or equal to 50 wt % and substantially less than or equal to 90 wt % (or namely the weight percentage of the acrylics of the sealant is between about 50 wt % and 90 wt %). In this embodiment, the dielectric anisotropy of the liquid crystal molecule 320, the weight percentage of the acrylics of the sealant 314, and the polarities of the liquid crystal molecule 320 and of the sealant 314 are all considered, and thus the problem of around mura may be completely resolved.

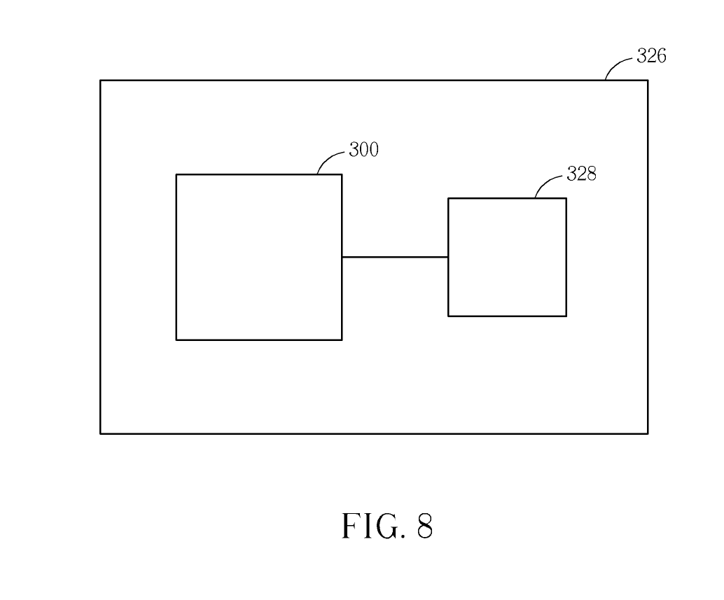

Please refer to FIG. 8. FIG. 8 illustrates an optoelectronic device of the embodiment of the present disclosure. As shown in FIG. 8, the optoelectronic device 326 includes a liquid crystal display panel 300 and an electric device 328 electrically connected to the liquid crystal display panel 300. The liquid crystal display panel 300 includes at least one of the liquid crystal display panels mentioned in the above embodiment. The electric device 328 includes control device, operation device, processing device, input device, memory device, driving device, light-emitting device, protect device, sensor device, detecting device, any other functional device, or a combination of devices mentioned above. Generally, the optoelectronic device 326 includes portable products (such as mobile phone, camera, recorder, notebook, game device, watch, music player, portable media player, e-mail receiver, navigator, digital photo frame, or similar products), media products (such as media player or similar products), display, television, digital broadcast, panel of projector, and etc.

In summary, one of the features of the liquid crystal display panel of the present disclosure is that the difference between the polarities of the sealant and of the liquid crystal molecule is enlarged, by, for example, improving the ratio of the acrylics of the sealant and by increasing the weight percentage of the acrylics of the sealant to about 50 wt % to about 90 wt %. Another feature is that in the case of increasing the weight percentage of the acrylics of the sealant between about 50 wt % and about 90 wt %, even combining the liquid crystal molecule with low driving voltage (such as the liquid crystal molecule with absolute dielectric anisotropy larger than about 7 or the liquid crystal molecule with dielectric anisotropy less than or equal to about −4), the problem of around mura caused by the dissolution of the sealant in the liquid crystal molecule in the conventional art, will not occur. As a result, the present invention may be applied to the liquid crystal display panel with low driving voltage to catch the trend of low energy consuming. Moreover, the embodiment mentioned above of the present disclosure uses two alignment films for example, but not limited thereto. For example, the design mentioned above may be also used on the liquid crystal display panel with only one alignment on one of the substrates in other embodiments.

Those skilled in the art will readily observe that numerous modifications and alterations of the device and method may be made while retaining the teachings of the disclosure.

What is claimed is:

1. A liquid crystal display panel, comprising:
a first substrate, comprising a display region and a sealant region, wherein the sealant region encompasses the display region;
a second substrate, disposed oppositely to the first substrate;
an active layer, disposed on the first substrate, wherein the active layer comprises a plurality of pixel areas disposed in the display region;
a first alignment film; disposed on the active layer;
a second alignment film, disposed on a side of the second substrate facing the active layer;
a liquid crystal layer, disposed between the first alignment film and the second alignment film, wherein the liquid crystal layer comprises a plurality of liquid crystal molecules, and a dielectric anisotropy of the liquid crystal molecules is substantially equal to or larger than 7; and
a sealant, disposed between the first substrate and the second substrate and in the sealant region, the liquid crystal layer being disposed in a space formed by the sealant, the first substrate and the second substrate, wherein the sealant comprises acrylics and a weight percentage of acrylics is substantially equal to or larger than 50 wt % and equal to or less than 90 wt %.

2. The liquid crystal display panel according to claim 1, wherein the dielectric anisotropy of the liquid crystal molecules is substantially between 7 and 25.

3. The liquid crystal display panel according to claim 2, wherein the dielectric anisotropy of the liquid crystal molecules is substantially between 7 and 14.

4. The liquid crystal display panel according to claim 1, wherein the weight percentage of acrylics is substantially equal to or larger than 80 wt % and equal to or less than 90 wt %.

5. The liquid crystal display panel according to claim 1, wherein acrylics comprise one of acrylic acid, methyl (meth)acrylate, methacrylic acid, 2-hydroxyethyl acrylate, 2-hydroxypropyl (meth)acrylate, 4-hydroxybutyl (meth)acrylate, 2-hydroxybutyl (meth)acrylate, isobutyl (meth)acrylate, tert-butyl (meth)acrylate, isooctyl (meth)acrylate, lauryl (meth)acrylate, stearyl (meth)acrylate, isobornyl (meth)acrylate, cyclohexyl (meth)acrylate, 2-methoxyethyl (meth)acrylate, methoxyethylene glycol (meth)acrylate, 2-ethoxyethyl (meth)acrylate, tetrahydrofurfuryl (meth)acrylate, benzyl (meth)acrylate, diethylene glycol monoethyl ether, phenoxyethyl (meth)acrylate, phenoxydiethylene glycol (meth)acrylate, phenoxypolyethylene glycol (meth)acrylate, methoxypolyethylene glycol (meth)acrylate, 2,2,2-trifluoroethyl (meth)acrylate, 2,2,3,3-tetrafluoropropyl (meth)acrylate, 1H,1H,5H-octafluoropentyl (meth)acrylate, imide (meth)acrylate, methyl (meth)acrylate, ethyl (meth)acrylate, propyl (meth)acrylate, n-butyl (meth)acrylate, cyclohexyl (meth)acrylate, 2-ethylhexyl (meth)acrylate, n-octyl (meth)acrylate, isononyl (meth)acrylate, isomyristyl (meth)acrylate, 2-butoxyethyl (meth)acrylate, 2-phenoxyethyl (meth)acrylate, bicyclopentenyl (meth)acrylate, isodecyl (meth)acrylate, diethylaminoethyl (meth)acrylate, dimethylaminoethyl (meth)acrylate, 2-(meth)acryloyloxyethyl succinate, 2-(meth)acryloyloxyethyl hexahydrophthalate, 2-(meth)acryloyloxyethyl 2-hydroxypropyl phthalate, glycidyl (meth)acrylate, 2-(meth)acryloyloxyethyl phosphate, 1.4-butanediol di(meth)acrylate, 1.3-butanediol di(meth)acrylate, 1,6-hexanediol di(meth)acrylate, 1,9-nonanediol di(meth)acrylate, 1,10-decanediol di(meth)acrylate), 2-n-butyl-2-ethyl-1,3-propanediol di(meth)acrylate, dipropylene glycol di(meth)acrylate, tripropylene glycol di(meth)acrylate, polypropylene glycol (meth)acrylate, ethylene glycol di(meth)acrylate, diethylene glycol di(meth)acrylate, tetraethylene glycol di(meth)acrylate, polyethylene glycol di(meth)acrylate, propylene oxide adduct of bisphenol A di(meth)acrylate, ethylene oxide adduct of bisphenol A di(meth)acrylate, ethylene oxide adduct of bisphenol F di(meth)acrylate, dimethylol-dicyclopentadien di(meth)acrylate, 1,3-butylene glycol di(meth)acrylate, neopentyl glycol di(meth)acrylate, ethylene oxide modified di(meth)acrylate isocyanurate, 2-hydroxy-3-(meth)acryloyloxypropyl (meth)acrylate, carbonatediol di(meth)acrylate, polyetherdiol di(meth)acrylate, polyesterdiol di(meth)acrylate, polycaprolactonediol di(meth)acrylate, and polybutadiendiol di(meth)acrylate or a combination of materials thereof.

6. The liquid crystal display panel according to claim 1, wherein a polarity of the sealant is substantially larger than a polarity of the liquid crystal molecules.

7. The liquid crystal display panel according to claim 6, wherein the polarity of the liquid crystal molecules is substantially between 20 and 22, and the polarity of the sealant is substantially equal to or larger than 23.

8. The liquid crystal display panel according to claim 6, wherein a difference from the polarity of the liquid crystal molecules to the polarity of the sealant is substantially equal to or larger than 2.

9. An optoelectronic device, comprising the liquid crystal display panel according to claim 1.

10. A liquid crystal display panel, comprising:
a first substrate, comprising a display region and a sealant region, wherein the sealant region encompassing the display region;
a second substrate, disposed oppositely to the first substrate;
an active layer, disposed on the first substrate, wherein the active layer comprises a plurality of pixel areas disposed in the display region;
a first alignment film, disposed on the active layer;
a second alignment film, disposed a side, facing the active layer, of the second substrate;
a liquid crystal layer, disposed between the first substrate and the second substrate, wherein the liquid crystal layer comprises a plurality of liquid crystal molecules; and
a sealant, disposed between the first substrate and the second substrate and in the sealant region, the liquid crystal layer being disposed in a space formed by the sealant, the first substrate, and the second substrate, wherein a polarity of the sealant is larger than a polarity of the liquid crystal layer.

11. The liquid crystal display panel according to claim 10, wherein the polarity of the liquid crystal molecules is substantially between 20 and 22.

12. The liquid crystal display panel according to claim 10, wherein the polarity of the sealant is substantially between 23 and 27.

13. The liquid crystal display panel according to claim 10, wherein a difference from the polarity of the liquid crystal molecules to the polarity of the sealant is substantially equal to or larger than 2.

14. The liquid crystal display panel according to claim 10, wherein a dielectric anisotropy of the liquid crystal molecules is substantially equal to or less than −4.

15. The liquid crystal display panel according to claim 10, wherein the sealant comprises acrylics and a weight percentage of acrylics is substantially equal to or larger than 50 wt % and equal to or less than 90 wt %.

16. The liquid crystal display panel according to claim 15, wherein acrylics comprise one of acrylic acid, methyl (meth)acrylate, methacrylic acid, 2-hydroxyethyl acrylate, 2-hydroxypropyl (meth)acrylate, 4-hydroxybutyl (meth)acrylate, 2-hydroxybutyl (meth)acrylate, isobutyl (meth)acrylate, tert-butyl (meth)acrylate, isooctyl (meth)acrylate, lauryl (meth)acrylate, stearyl (meth)acrylate, isobornyl (meth)acrylate, cyclohexyl (meth)acrylate, 2-methoxyethyl (meth)acrylate, methoxyethylene glycol (meth)acrylate, 2-ethoxyethyl (meth)acrylate, tetrahydrofurfuryl (meth)acrylate, benzyl (meth)acrylate, diethylene glycol monoethyl ether, phenoxyethyl (meth)acrylate, phenoxydiethylene glycol (meth)acrylate, phenoxypolyethylene glycol (meth)acrylate, methoxypolyethylene glycol (meth)acrylate, 2,2,2-trifluoroethyl (meth)acrylate, 2,2,3,3-tetrafluoropropyl (meth)acrylate, 1H,1H,5H-octafluoropentyl (meth)acrylate, imide (meth)acrylate, methyl (meth)acrylate, ethyl (meth)acrylate, propyl (meth)acrylate, n-butyl (meth)acrylate, cyclohexyl (meth)acrylate, 2-ethylhexyl (meth)acrylate, n-octyl (meth)acrylate, isononyl (meth)acrylate, isomyristyl (meth)acrylate, 2-butoxyethyl (meth)acrylate, 2-phenoxyethyl (meth)acrylate, bicyclopentenyl (meth)acrylate, isodecyl (meth)acrylate, diethylaminoethyl (meth)acrylate, dimethylaminoethyl (meth)acrylate, 2-(meth)acryloyloxyethyl succinate, 2-(meth)acryloyloxyethyl hexahydrophthalate, 2-(meth)acryloyloxyethyl 2-hydroxypropyl phthalate, glycidyl (meth)acrylate, 2-(meth)acryloyloxyethyl phosphate, 1.4-butanediol di(meth)acrylate, 1.3-butanediol di(meth)acrylate, 1,6-hexanediol di(meth)acrylate, 1,9-nonanediol di(meth)acrylate, 1,10-decanediol di(meth)acrylate), 2-n-butyl-2-ethyl-1,3-propanediol di(meth)acrylate, dipropylene glycol di(meth)acrylate, tripropylene glycol di(meth)acrylate, polypropylene glycol (meth)acrylate, ethylene glycol di(meth)acrylate, diethylene glycol di(meth)acrylate, tetraethylene glycol di(meth)acrylate, polyethylene glycol di(meth)acrylate, propylene oxide adduct of bisphenol A di(meth)acrylate, ethylene oxide adduct of bisphenol A di(meth)acrylate, ethylene oxide adduct of bisphenol F di(meth)acrylate, dimethylol-dicyclopentadien di(meth)acrylate, 1,3-butylene glycol di(meth)acrylate, neopentyl glycol di(meth)acrylate, ethylene oxide modified di(meth)acrylate isocyanurate, 2-hydroxy-3-(meth)acryloyloxypropyl (meth)acrylate, carbonatediol di(meth)acrylate, polyetherdiol di(meth)acrylate, polyesterdiol di(meth)acrylate, polycaprolactonediol di(meth)acrylate, and polybutadiendiol di(meth)acrylate or a combination of materials thereof.

17. An optoelectronic device, comprising the liquid crystal display panel according to claim 10.

18. A liquid crystal display panel, comprising:
a first substrate, comprising a display region and a sealant region, wherein the sealant region encompassing the display region;
a second substrate, disposed oppositely to the first substrate;
an active layer, disposed on the first substrate, wherein the active layer comprises a plurality of pixel areas disposed in the display region;
a first alignment film, disposed on the active layer;
a second alignment film, disposed a side, facing the active layer, of the second substrate;
a liquid crystal layer, disposed between the first substrate and the second substrate, wherein the liquid crystal layer comprises a plurality of liquid crystal molecules, and a dielectric anisotropy of the liquid crystal molecules is substantially equal to or less than −4; and
a sealant, disposed between the first substrate and the second substrate and in the sealant region, the liquid crystal layer being disposed in a space formed by the sealant, the first substrate, and the second substrate, wherein the sealant comprises acrylics and a weight percentage of acrylics is substantially equal to or larger than 50 wt % and equal to or less than 90 wt %.

19. The liquid crystal display panel according to claim 18, wherein the dielectric anisotropy of the liquid crystal molecules is substantially between −4 and −25.

20. The liquid crystal display panel according to claim 18, wherein the dielectric anisotropy of the liquid crystal molecules is substantially between −4 and −14.

21. The liquid crystal display panel according to claim 18, wherein the weight percentage of acrylics is substantially equal to or larger than 80 wt % and equal to or less than 90 wt %.

22. The liquid crystal display panel according to claim 18, wherein acrylics comprise one of acrylic acid, methyl (meth)acrylate, methacrylic acid, 2-hydroxyethyl acrylate, 2-hydroxypropyl (meth)acrylate, 4-hydroxybutyl (meth)acrylate, 2-hydroxybutyl (meth)acrylate, isobutyl (meth)acrylate, tert-butyl (meth)acrylate, isooctyl (meth)acrylate, lauryl (meth)acrylate, stearyl (meth)acrylate, isobornyl (meth)acrylate, cyclohexyl (meth)acrylate, 2-methoxyethyl (meth)acrylate, methoxyethylene glycol (meth)acrylate, 2-ethoxyethyl (meth)acrylate, tetrahydrofurfuryl (meth)acrylate, benzyl (meth)acrylate, diethylene glycol monoethyl ether, phenoxyethyl (meth)acrylate, phenoxydiethylene glycol (meth)acrylate, phenoxypolyethylene glycol (meth)acrylate, methoxypolyethylene glycol (meth)acrylate, 2,2,2-trifluoroethyl (meth)acrylate, 2,2,3,3-tetrafluoropropyl (meth)acrylate, 1H,1H,5H-octafluoropentyl (meth)acrylate, imide (meth)acrylate, methyl (meth)acrylate, ethyl (meth)acrylate, propyl (meth)acrylate, n-butyl (meth)acrylate, cyclohexyl (meth)acrylate, 2-ethylhexyl (meth)acrylate, n-octyl (meth)acrylate, isononyl (meth)acrylate, isomyristyl (meth)acrylate, 2-butoxyethyl (meth)acrylate, 2-phenoxyethyl (meth)acrylate, bicyclopentenyl (meth)acrylate, isodecyl (meth)acrylate, diethylaminoethyl (meth)acrylate, dimethylaminoethyl (meth)acrylate, 2-(meth)acryloyloxyethyl succinate, 2-(meth)acryloyloxyethyl hexahydrophthalate, 2-(meth)acryloyloxyethyl 2-hydroxypropyl phthalate, glycidyl (meth)acrylate, 2-(meth)acryloyloxyethyl phosphate, 1.4-butanediol di(meth)acrylate, 1.3-butanediol di(meth)acrylate, 1,6-hexanediol di(meth)acrylate, 1,9-nonanediol di(meth)acrylate, 1,10-decanediol di(meth)acrylate), 2-n-butyl-2-ethyl-1,3-propanediol di(meth)acrylate, dipropylene glycol di(meth)acrylate, tripropylene glycol di(meth)acrylate, polypropylene glycol (meth)acrylate, ethylene glycol di(meth)acrylate, diethylene glycol di(meth)acrylate, tetraethylene glycol di(meth)acrylate, polyethylene glycol di(meth)acrylate, propylene oxide adduct of bisphenol A di(meth)acrylate, ethylene oxide adduct of bisphenol A di(meth)acrylate, ethylene oxide adduct of bisphenol F di(meth)acrylate, dimethylol-dicyclopentadien di(meth)acrylate, 1,3-butylene glycol di(meth)acrylate, neopentyl glycol di(meth)acrylate, ethylene oxide modified di(meth)acrylate isocyanurate, 2-hydroxy-3-(meth)acryloyloxypropyl (meth)acrylate, carbonatediol di(meth)acrylate, polyetherdiol di(meth)acrylate, polyesterdiol di(meth)acrylate, polycaprolactonediol di(meth)acrylate, and polybutadiendiol di(meth)acrylate or a combination of materials thereof.

23. An optoelectronic device, comprising the liquid crystal display panel according to claim 18.
